(19) United States
(12) Patent Application Publication
(10) Pub. No.: US 2014/0271183 A1
(43) Pub. Date: Sep. 18, 2014

(54) Wind Turbine with Variable Pitch Blades

(71) Applicant: Gerald L. Barber, Greenville, SC (US)

(72) Inventor: Gerald L. Barber, Greenville, SC (US)

(21) Appl. No.: 13/833,055

(22) Filed: Mar. 15, 2013

(51) Int. Cl. F03D 7/02

(52) U.S. Cl. CPC F03D 7/0224
USPC 416/1; 416/155; 416/147

(57) ABSTRACT

A wind turbine including a blade pitch control ring mounted coaxially with and rotatable with the wind turbine, and an angle control arm connected between the blade pitch control ring and each of the turbine blades for simultaneously changing the pitch of all of the turbine blades.

### FIELD OF THE INVENTION

This invention concerns a wind turbine for the generation of electricity that includes a turbine wheel rotatably mounted on a laterally extending central axis, with the perimeter rim of the turbine wheel engaging electrical generators for the generation of electricity.

### BACKGROUND OF THE INVENTION

Windmills have been used for many years for the purpose of pumping water from the ground and for generating electricity. The basic advantage of the windmill is that it uses the power of the wind to rotate a wheel having radially extending blades that are driven by the wind. This rotary movement may be converted into various useful purposes. For example, wind turbines in the form of propellers mounted on towers have been placed in areas where steady winds are prevalent and the wind turbines are used to generate electricity.

The blades of the current conventional wind turbines usually are very large and made of expensive rigid material and are constructed to have the blades extend radially from a central hub, with no extra support at the outer tips of the blades. The conventional wind turbine blades rotate at a high rate of revolution and must withstand both the centrifugal forces generated by the fast revolution of the blades and the cantilever bending forces applied to the blades by the wind, pushing the blades in a rearward direction. Since the outer portions of the blades may be engaged by strong winds moving at a very high velocity, the larger the blades the stronger they must be and the more expensive they become. Therefore, there is a practical limit as to the length and width of the blades because of the expense of stronger materials for larger blades.

The prior art reveals some turbine wheels that have been constructed with circular rims surrounding the tips of the blades, with the rims supporting the blades at the outer ends of the blades. This tends to reduce the stress applied by the wind to the blades, but the circular rims add more weight to the structure and present more wind resistance that increases the tipping forces applied to the mast that supports the turbine wheel.

Another type of wind turbine is one that has blades in the form of sail wings constructed of cloth or other light weight, flexible material as a substitute for the rigid blades. For example U.S. Pat. Nos. 8,174,142 and 8,258,645 disclose wind turbines that do not use rigid propeller blades but use sails that catch the wind. These types of windmills use outer circular rims with the sails of the turbine supported by the rims. The outer rim supports the outer portions of the sails so that the axial forces of the wind applied to the sails may be absorbed to a major extent by the outer rim so that there is little if any cantilever force applied to the sails. This allows the blades of the wind turbine to be formed of lighter weight material, material that is not required to bear as much stress in comparison to the typical free bladed turbine.

One of the important features of the modern wind turbine is the ability of the turbine to rotate the blades, to change the pitch of the blades for adjusting to the change in velocity of the wind or when starting or stopping the rotation of the turbine wheel.

The apparent wind near the tip of the blade of a windmill is faster than at the root of the blade and is at a different angle than the wind at the root of the blade. Whenever the wind is blowing faster or slower than the designed blade wind speed, the angle of the blade may be controlled so as to adjust the blade to get the best angle of attack near the tip of the blade. The greater amount of power is harvested near the tip of the blade where most of the sweet area or width of the blade is present.

It is desirable to turn the windmill blades about their longitudinal axes when the velocity of the wind changes so as to control the speed of the windmill.

Thus, it would be desirable to provide a wind turbine that has support for the outer ends of the turbine blades as well as the inner ends of the turbine blades, and to provide means for adjusting the pitch of the blades during continuous operation of the windmill, thereby controlling the speed of the rotation of the turbine wheel. It would be desirable to have the advantage of changing the pitch of the blades of the windmill with minimum amount of apparatus necessary to turn the blades, preferably with using only one turning apparatus for all of the blades of the turbine.

### SUMMARY OF THE DISCLOSURE

Briefly described, this disclosure sets forth features of a wind turbine that is powered by atmospheric wind and which can be used to create rotary energy that is transformed into an end product, such as to drive an electrical generator. The end use may vary in accordance with need, but a practical end use for the wind turbine is to create electricity by driving one or more electrical generators.

This disclosure concerns a wind turbine that includes a central shaft rotatable about a horizontal axis, a plurality of turbine blades extending radially from the central shaft, and rotatable with the central shaft about the horizontal axis. A blade pitch control ring is positioned coaxially with the central shaft and is rotatable with the rotation of the central shaft about the horizontal axis, and a blade angle control means extends between the blade angle control ring and each of the turbine blades for maintaining each of the turbine blades at the same pitch. Further, the blade angle control means may include a connector arm, including a ring connection segment and a blade connection segment and a swiveling and articulating joint connecting the blade connection segment and the ring connection segment.

The swiveling and articulating joint that connects the blade to the blade pitch control ring may comprise a connector ball and a connector socket mounted about the connector ball, which is common to the construction of a ball hitch of the type used to mount a trailer to a towing vehicle, such as a truck.

Another feature disclosed herein is the blade pitch control motor connected to one of the turbine blades for changing the pitch of one of the turbine blades. The turbine blade that is turned by the control motor in turn rotates the pitch control ring about its axis, and the pitch control ring moves so as to rotate the other sail wings about their respective longitudinal axes.

The turbine blades each may include a spar extending radially from the central shaft of the wind turbine and blade angle control is connected to the spar of each turbine blade. A perimeter rim may be utilized at the outer tips of the turbine blades to stabilize and support each turbine blade. The spars of the turbine blades are mounted at both inner and outer ends thereof to universal joints to accommodate for the bending of the blades with respect to the perimeter rim and with respect to the central axis of the turbine.

The blade pitch control ring is movable along the central shaft of the wind turbine and about the horizontal axis of the central shaft.

Another feature of the invention is the method controlling the pitch of a plurality of turbine blades mounted about and extending radially from a common axle of rotation. A turning blade pitch control ring is mounted coaxially with the common axle of rotation about the common axle of rotation, and the pitch of the plurality of turbine blades is changed in response to turning the blade pitch control ring.

Another desired feature of wind turbines is to have them constructed of parts that fit together but that have sizes, configurations and weights that are compatible with transport over public roads so as to reduce the transportation costs of the parts from various places of fabrication to the site of erection of the wind turbine. While some of the wind turbines formed with cantilever blades and support masts typically are not easy to transport, the wind turbine as disclosed herein is more suitable for expedient and convenient transport to the erection site.

Other features and advantages of the present disclosure will become apparent upon reading the following specification, when taken in conjunction with the accompanying drawings.

### BRIEF DESCRIPTION OF THE DRAWINGS

FIG. 1 is a front elevational view, with a portion broken away, of the wind turbine that has variable pitch blades, showing how the wind turbine may be mounted on a skeletal framework.

FIG. 2A is a segment of the turbine wheel of a wind turbine of FIG. 1, showing one of the sail wings and cables that support the perimeter rim of the turbine wheel.

FIG. 2B is a close-up view of the base of a sail wing, showing how the sail wing may be rotated about its spar.

FIG. 3 is a side elevational view of a blade pitch control motor that is connected to the spar of one of the turbine blades for changing the pitch of all of the turbine blades.

FIGS. 4A, 4B, and 4C are transparent views of a blade of the turbine wheel, with FIGS. 4B and 4C illustrating how the spar extends longitudinally through the blade, and with 4B showing how the universal joints support the blade at its ends.

FIG. 5 is perspective view of the inner end portions of adjacent ones of the sail wings and the angle control means that controls the pitch of the blades, including the angle control ring and the swiveling and articulating joint connection between the spar of the sail wings and the connection to the angle control ring.

FIGS. 6 and 7 are similar to FIG. 5, with each of FIGS. 5, 6, and 7 showing the connector arm at different orientations.

FIG. 8 is a side view of the swivel and articulating joint 70, showing the connection between the blade pitch control ring and a spar of a wind sail.

FIG. 9 is a side elevational view, similar to FIG. 8, but showing the swiveling and articulating movement of the blade pitch control ring 34 with respect to the spar of the sail wing.

### DETAILED DESCRIPTION

Referring now in more detail to the drawings in which like numerals indicate like parts throughout the several views, FIG. 1 schematically illustrates a wind turbine 10 that is mounted on a support structure 12 at its site of installation where it will operate to generate electricity.

Generally, the support structure 12 may include a concrete base 14 that is poured on site, and a skeletal support structure 16 that includes a horizontal platform 18 mounted on upright support posts 20. A vertical mast 22 extends upwardly from the horizontal platform 18 and supports the turbine wheel 24 and its components.

Generally, the turbine wheel includes a central shaft 26 rotatable about a horizontal axis supported at the top of mast 22, a plurality of sail wings 28, and a perimeter rim 30. The sail wings are connected by universal joints 32 at their outermost ends to the perimeter rim 30, and at their inner ends (not shown in FIG. 1) to the central shaft 26.

Blade pitch control ring 34 is mounted at the center of the wind turbine, coaxially with the central shaft 26, and is rotatable with the central shaft about a horizontal axis 35. The blade pitch control ring is rotatable in unison with the central shaft about the horizontal axis.

FIG. 2A provides a more detailed view of one of the sail wings 28. The sail wings are twisted along their lengths to form a “pitch” that is compatible with the angular velocity of the sail wing and the oncoming atmospheric wind. This is conventional in the art. Each sail wing includes its own spar 36 that extends longitudinally of the sail wing, with the spar being supportive of the material of the sail wing 28. A plurality of radially extending support wires 38 extend from the central shaft 26 radially outward for connection at the outer terminal ends to the perimeter rim 30. The support wires support the perimeter rim 30 and the plurality of sail wings 28.

As shown in FIG. 2B, the central shaft 26 extends along the axis of rotation of the wind turbine, and the support wires 38 are attached at the outer ends of the central shaft 26, providing sufficient angles for stabilizing forces for the perimeter rim 30.

FIG. 3 is an enlargement of the central portion of FIG. 2B, showing the inner end portion 40 of a sail wing 28, and spar 36. The spar is connected by a universal joint 42 to drive shaft 44. The lower portion of the drive shaft is mounted to a bearing 46 so that the drive shaft is rotatable with respect to main bearing 48 of the central shaft 26.

Blade pitch drive 50 is mounted on the support platform 52 which, in turn, is supported by the main bearing 48. Blade pitch drive 50 includes an electric motor 54, brake 56, and gear head 58. The gear head rotates sprocket 60 that engages a driven sprocket 62 that is mounted to drive shaft 44. With this arrangement, the electric motor 54 operates to rotate the drive shaft 44 and universal joint 42 and spar 36 so as to tilt the sail wing 28 shown in FIG. 3 about the radial axis 64, thereby changing the pitch of the sail wing 28A of FIG. 3.

FIGS. 4A, 4B and 4C shown different views of a sail wing. FIG. 4A illustrates the sail wing 28 with cross sections of the sail wing shown at different intervals along the height of the sail wing.

FIG. 4B illustrates the side view of a sail wing, showing the pitch of the sail wing from inner to outer ends, with the outer end connected by universal joint 32 to the perimeter rim 30. The spar 36 extends from the base to the tip of the sail wing and controls the rigidity/flexibility of the sail wing, without requiring it to be under tension or compression with respect to the perimeter rim 30. The inner end of spar 36 is connected by another universal joint 42 to the blade pitch drive 50.

FIG. 5 is a partial view of central shaft 26, showing the base portions of three adjacent sail wings 28A, 28B and 28C. All of the sail wings are attached to the central shaft 26 of the wind turbine with universal joints, with the base section of the universal joint 42A mounted to the central shaft 26 and the outer portion of the universal joint 42B pivotally connected to the inner portion 42A in the conventional manner. The spar 36 of the sail wing 28B is mounted to the outer portion 42B of the universal joint 42. This allows the spar 36 to move freely with respect to central shaft 26 of the turbine wheel 24.

A swiveling and articulating joint 70 is rigidly connected to the spar 36 of each sail wing 28 and at its other end to the blade pitch control ring 34.

The swiveling and articulating joint 70 functions as a blade pitch control means extending between the blade pitch control ring 34 and the spar 36 of the sail wing 28B. The swiveling and articulating joint 70 includes a spar connection arm 72 rigidly connected to spar 36 and a ring connection arm 74 rigidly connected to blade pitch control ring 34, and connected together at the connection 76 that provides for both swiveling movements and articulating movements.

An example of a swiveling and articulating joint is illustrated in FIG. 8 as a conventional hitch ball 78 and a ball socket 80 that is of corresponding shape of the pitch ball, and a ball clamp 82 that is spring urged toward locking relationship with respect to the hitch ball 78. This is conventional in trailer hitch technology.

When the spar 36 is rotated on its longitudinal axis 37, as shown in FIG. 10, the swiveling and articulating joint 70 rotates about the spar longitudinal axis 37 as indicated by arrows 84 and 85 so that the hitch ball 78 moves in an arc. The movement of the hitch ball 78 results in corresponding movement of the blade pitch control ring 34, causing the ring to move closer to the spar longitudinal axis 37 and to rotate the blade pitch control ring 34 to a closer position, as indicated by arrow 86 of FIG. 10.

Also, as shown in FIG. 9, when the spar 36 is rotated about its longitudinal axis as indicated by arrow 84, the ring connection arm 74 is also required to rotate about its circular shape so that the hitch ball 78 is at a higher elevation than the connection to the blade pitch control ring 34. Therefore, by comparing FIGS. 9 and 10, FIG. 9 shows the articulating movement between spar 36 and blade pitch control ring, and the swiveling movement between spar 36 and blade pitch control ring.

Since the blade pitch control ring 34 is connected to each one of the spars 36 of each sail wing when the blade pitch control ring moves as indicated in FIGS. 9 and 10, the rigid connection between the blade pitch control ring 34 and the swiveling and articulating joint 70 will cause all of the spars to rotate in unison and through equal arcuate angles. Therefore, when the blade pitch drive 50 (FIG. 3) rotates one of the spars 36, the driven spar will move the blade pitch control ring 34 and the blade pitch control ring 34 will cause equal movement of all of the other swiveling and articulating joints 70, resulting in equal movements of all of the spars 36. Therefore, only one blade pitch drive 50 is required to control the rotation of all of the sail wings 28 of the wing turbine 10.

This is illustrated by the vector diagram of FIG. 10 showing how the curved movement has rectilinear components of movement toward and inward with respect the final position of the moving object.

A comparison of FIGS. 5-7 will illustrate the movements; FIGS. 6 and 7 will demonstrate different positions of the swiveling and articulating joint 70.

FIG. 10 is a vector diagram of the movement of the blade pitch control ring 34 showing how the ring moves through an arc 88. The rotational movement is shown at 89 and the axial movement is shown at 90, indicating the combined movements that create the combined movement 88.

It will be understood by those skilled in the art that while the foregoing description and illustrations set forth in detail a preferred embodiment of the present invention, modifications, additions, and deletions might be made thereto without departing from the spirit and scope of the invention, as set forth in the following claims.

1. A wind turbine comprising
a central shaft rotatable about a horizontal axis,
a plurality of turbine blades extending radially from said central shaft and rotatable with said central shaft about said horizontal axis,
a blade pitch control ring coaxial with said central shaft and rotatable with the rotation of said central shaft about said horizontal axis,
blade pitch control means extending between said blade angle control ring and each of said turbine blades for maintaining each said turbine blade at the same pitch.

2. The wind turbine of claim 1, wherein said blade pitch control means comprises a connector arm including a ring connection segment and a blade connection segment and a swiveling and articulating joint connecting said blade connection segment and said ring connection segment.

3. The wind turbine of claim 2, wherein said swiveling and articulating joint comprises a connector ball and a connector socket mounted about said connector ball.

4. The wind turbine of claim 1, and further including a blade pitch control motor connected to one of said turbine blades for changing the pitch of one of said turbine blades.

5. The wind turbine of claim 1 wherein said turbine blades each includes a spar extending radially from said central shaft, and said blade pitch control means is connected to the spar of each turbine blade.

6. The wind turbine of claim 1, and further including a perimeter rim extending about said plurality of turbine blades, and
a universal joint connecting said turbine blades to said perimeter rim.

7. The wind turbine of claim 6, and further including a universal joint connecting each said turbine blade to said central shaft.

8. The wind turbine of claim 1, wherein said blade pitch control ring is movable along said central shaft and about said horizontal axis of said central shaft.

9. A method of controlling the pitch of a plurality of turbine blades mounted about and extending radially from a common axle of rotation, comprising
turning a blade pitch control ring mounted coaxially with said common axle of rotation about the common axle of rotation,
in response to turning the blade pitch control ring about the axle of rotation simultaneously changing the pitch of the plurality of said turbine blades.

10. The method of claim 9, and further including the step of turning the pitch control ring in response to turning the pitch of one of said turbine blades.

11. The method of claim 9, and wherein the step of changing the pitch of the plurality of said turbine blades comprises rotating the turbine blades with an articulating and swiveling arm extending between the pitch control ring and the turbine blades.

12. The method of claim 9 and wherein the step of changing the pitch of the plurality of said turbine blades comprises rotating the turbine blades with ball hitch couplers connected between said pitch control ring and the turbine blades.

13. A wind turbine comprising
a central shaft rotatable about a horizontal axis,
a plurality of turbine blades extending radially from said central shaft and rotatable with said central shaft about said horizontal axis,
a blade pitch control ring coaxial with said central shaft and rotatable with the rotation of said central shaft about said horizontal axis,
blade pitch control means extending between said blade pitch control ring and each of said turbine blades for maintaining each said turbine blade at the same pitch,
said blade pitch control means including a blade control arm rigidly connected to each of said turbine blades, and a ring connector arm for each blade control arm connected to said blade pitch control ring, and
an articulating and swiveling connection between said blade control arm and said pitch control ring.

14. The wind turbine of claim 13, wherein said articulating and swiveling joint comprises a connector ball and a connector socket mounted about said connector ball.

15. The wind turbine of claim 13, and further including a blade pitch control motor connected to one of said turbine blades for changing the pitch of all of said turbine blades.

16. The wind turbine of claim 13, wherein said turbine blades each includes a spar extending radially from said central shaft, and wherein said blade angle control means is connected to the spar of each turbine blade.

17. The wind turbine of claim 13, a perimeter rim extending about said plurality of turbine blades, and
a universal joint connecting said turbine blades to said perimeter rim.

18. The wind turbine of claim 13, and further including a universal joint connecting each said turbine blade to said central shaft.

19. A wind turbine comprising
a blade pitch control ring mounted coaxially with and rotatable with the wind turbine, and
an angle control arm connected between the blade pitch control ring and each of the turbine blades for simultaneously changing the pitch of all of the turbine blades in response to the rotation of one of said turbine blades.

20. The wind turbine of claim 19, wherein said angle control arm includes a blade control arm connected to each of said turbine blades,
a ring connector arm connected to said pitch control ring, and
a ball and socket connection between said blade control arm and said ring connector arm.

21. A wind turbine comprising
a rotatable central shaft oriented horizontally and a perimeter rim concentric with and rotatable with said central shaft,
a plurality of sail wings extending radially from said central shaft toward said perimeter ring,
each said sail wing including a support spar extending radially from said central shaft toward said perimeter rim,
each said support spar including an inner end portion rotatably supported by said central shaft and an outer end portion rotatably supported by said perimeter rim, such that the pitch of the sail wings changes in response to the rotation of said spars.

22. The wind turbine of claim 21, and further including:
an inner universal joint connected between said central shaft and said inner end portion of each said spar and supporting said inner end portion of each said spar from said central shaft, and
an outer universal joint connected between said outer end portion of each said spar and said perimeter rim and supporting said outer end portion of each said spar from said perimeter rim, such that said spars support the sail wings and retard bending of the sail wings in response to atmospheric wind applied to said sail wings.
